(19) United States
(12) Patent Application Publication
(10) Pub. No.: US 2019/0005842 A1
(43) Pub. Date: Jan. 3, 2019

(54) INFORMATION PROCESSING APPARATUS, INFORMATION PROCESSING METHOD, AND PROGRAM

(71) Applicant: Sony Corporation, Tokyo (JP)

(72) Inventors: Seijiro Inaba, Kanagawa (JP); Hiroshi Ikeda, Tokyo (JP); Nobuho Ikeda, Kanagawa (JP)

(21) Appl. No.: 15/752,997

(22) PCT Filed: Jul. 22, 2016
(86) PCT No.: PCT/JP2016/003428

§ 371 Date: Feb. 15, 2018

(30) Foreign Application Priority Data
Sep. 29, 2015 (JP) 2015-191437

(51) Int. Cl. G09B 19/00; G06F 17/30

(52) U.S. Cl. CPC G09B 19/00; G06F 17/30946

(57) ABSTRACT

There is provided an information processing method including receiving motion information indicative of a motion of a user and result information indicative of a result obtained from the motion of the user, associating the motion information and the result information with each other, and classifying the motion information based at least in part on the association of the motion information and the result information with each other.

### CROSS REFERENCE TO RELATED APPLICATIONS

This application claims the benefit of Japanese Priority Patent Application JP 2015-191437 filed Sep. 29, 2015, the entire contents of which are incorporated herein by reference.

### TECHNICAL FIELD

The present disclosure relates to an information processing apparatus, an information processing method, and a program.

### BACKGROUND ART

In recent years, for example, various electronic devices have been introduced in the field of sports to provide support for facilitating the improvement in the user's skill. Techniques for recognizing the state of a ball or for facilitating the improvement in the user's skill are developed. Examples of a technique for recognizing the position of a ball in flight, the ball's rotating state, moving direction and moving speed in real time include the technique disclosed in PTL 1. Furthermore, examples of a technique for automatically analyzing the behavior of a ball and for presenting an improvement in motions in ball games to the user include the technique disclosed in PTL 2.

### CITATION LIST

### Patent Literature

PTL 1: JP 2007-014671A

PTL 2: JP 2009-125509A

### SUMMARY

### Technical Problem

The case in which the user practices a sport will be described as an example. The use of a ball to which the technique disclosed in PTL 1 or 2 is applied or electronic apparatus such as radar used to capture the movement of a ball or the like allows behavior of the ball or the like when the user's motion is performed to be recorded.

However, even when the behavior of a ball or the like can be recorded, the user is difficult to understand improvement points of the motion from the recorded behavior of a ball or the like.

For example, when the technique disclosed in PTL 2 is employed, the recorded behavior of a ball is automatically analyzed. When the technique disclosed in PTL 2 is employed as an example, the determination of whether behavior of the ball is good or bad is performed for each item previously set, and a previously set improvement corresponding to a result obtained by the determination is presented.

The motion herein is assumed to be different for every user, and in some cases, results obtained by determining whether it is good or bad, which is performed for the ball's behavior recorded for the different motions are assumed to be the same. However, the improvement presented to the user when the technique disclosed in PTL 2 is employed is previously associated with the results obtained by the determination of whether the recorded ball's behavior is good or bad. Thus, the improvement presented to the user is not necessarily the only one suitable for the user.

Therefore, when the existing technique as described above is employed, the user is not necessarily able to achieve the skill improvement in motions for any target involving a motion such as sports.

An embodiment of the present disclosure provides a novel and improved information processing apparatus, information processing method, and program, capable of facilitating the skill improvement in the user's motion.

### Solution to Problem

According to an embodiment f the present disclosure, there is provided an information processing method including receiving motion information indicative of a motion of a user and result information indicative of a result obtained from the motion of the user, associating the motion information and the result information with each other, and classifying the motion information based at least in part on the association of the motion information and the result information with each other.

According to an embodiment of the present disclosure, there is provided an information processing system including one or more external observers and a control unit. The one or more external observers configured to generate motion information indicative of a motion of a user and result information indicative of a result obtained from the motion of the user, and output the motion information and the result information. The control unit having an association processing unit and a classification unit. The association processing unit is configured to receive the motion information and the result information, and associate the motion information and the result information with each other. The classification unit is configured to classify the motion information based at least in part on the association of the motion information and the result information with each other.

According to an embodiment of the present disclosure, there is provided a non-transitory computer-readable medium including instructions, that when executed by an electronic processor, cause the electronic processor to perform a set of functions. The set of functions including receiving motion information indicative of a motion of a user and result information indicative of a result obtained from the motion of the user, associating the motion information and the result information with each other, and classifying the motion information based at least in part on the association of the motion information and the result information with each other.

### Advantageous Effects of Invention

According to the embodiments of the present disclosure, it is possible to facilitate the skill improvement in the user's motion.

Note that the effects described above are not necessarily limited, and along with or instead of the effects, any effect that is desired to be introduced in the present specification or other effects that can be expected from the present specification may be exhibited.

### BRIEF DESCRIPTION OF DRAWINGS

FIG. 1 is a block diagram illustrating an exemplary configuration of an information processing apparatus according to an embodiment of the present disclosure.

FIG. 2 is a diagram illustrated to describe an exemplary hardware configuration of the information processing apparatus according to an embodiment of the present disclosure.

FIG. 3 is a diagram illustrated to describe an information processing method according to an embodiment of the present disclosure.

FIG. 4 is a diagram illustrated to describe an information processing method according to an embodiment of the present disclosure.

FIG. 5 is a diagram illustrated to describe an exemplary process for implementing the information processing method according to an embodiment of the present disclosure.

FIG. 6 is a diagram illustrated to describe an exemplary process for implementing the information processing method according to an embodiment of the present disclosure.

FIG. 7 is a diagram illustrated to describe an exemplary process for implementing the information processing method according to an embodiment of the present disclosure.

FIG. 8 is a diagram illustrated to describe an exemplary process for implementing the information processing method according to an embodiment of the present disclosure.

FIG. 9 is a diagram illustrated to describe an exemplary process for implementing the information processing method according to an embodiment of the present disclosure.

FIG. 10 is a flowchart illustrating an exemplary process for implementing the information processing method according to an embodiment of the present disclosure.

### DESCRIPTION OF EMBODIMENTS

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

The description will be given in the order of items shown below.
1. Information Processing Method according to Present Embodiment
2. Information Processing Apparatus according to Present Embodiment
4. Program according to Present Embodiment

### Information Processing Method According to Present Embodiment

First, the configuration of an information processing apparatus according to an embodiment of the present disclosure will be described. As an example, the case will be described where a process for implementing the information processing method according to the present embodiment is performed by the information processing apparatus according to the embodiment.

The following description will be mainly given of a case where the user is practicing sports such as golf and tennis as an example. However, the information processing method according to the present embodiment can also be applied to a case where the user performs a practice for any target involving a motion such as strength training, cooking, and procedure in medical care.

### <1< Overview of Information Processing Method According to Present Embodiment

As described above, it can be performed “to simply record behavior of a ball or the like” or “to present the user with an improvement previously associated with a result obtained by the determination of whether the recorded behavior of a ball or the like is good or bad”. However, in this case, the user is not necessarily able to achieve the skill improvement in motions such as sports.

Thus, the information processing apparatus according to the present embodiment associates a user's motion with a result obtained from the user's motion (association process). The motion according to the present embodiment herein includes one or both of a posture (a pose during an exercise or the like) and a movement.

The user's motion is associated with the result of the user's motion by the association process, and thus, as an example, “the type of a result obtained depending on the type of behavior of the user” becomes apparent. The association of the user's motion with the result of the user's motion allows “the user to understand one or both of the motion when a satisfactory result is obtained and the motion when an unsatisfactory result is obtained”, as an example.

Thus, it is possible for the information processing apparatus according to the present embodiment to facilitate the skill improvement in the user's motion by performing the association process as a process for implementing the information processing method according to the present embodiment.

### <2> Other Examples of Process for implementing Information Processing Method According to Present Embodiment

Note that the process for implementing the information processing method according to the present embodiment is not limited to the association process described above.

As one example, the information processing apparatus according to the present embodiment is further capable of performing an evaluation process for evaluating the results of the user's motion.

When the evaluation process is further performed, the information processing apparatus according to the present embodiment is further capable of performing one or more processes using a result of the association process and a result of the evaluation process. Examples of the process using a result of the association process and a result of the evaluation process include “classification process”, “classification and analysis processes”, or “classification, analysis, and notification processes”, which will be described later.

Note that “the association process”, “the association and evaluation processes”, and “the association process, the evaluation process, and the process using a result of the association process and a result of the evaluation process” are those obtained by dividing the process for implementing the information processing method according to the present embodiment for convenience sake. Thus, in the process for implementing the information processing method according to the present embodiment, for example, each of “the association and evaluation processes”, and “the association process, the evaluation process, and the process using a result of the association process and a result of the evaluation process” can be understood as one process. In addition, in the process for implementing the information processing method according to the present embodiment, each of “the association process”, “the association and evaluation processes”, and “the association process, the evaluation process, and the process using a result of the association process and a result of the evaluation process” can also be understood as two or more processes (using any suitable division way).

### Information Processing Apparatus According to Present Embodiment

An exemplary configuration of the information processing apparatus according to the present embodiment capable of performing the process for implementing the information processing method according to the present embodiment described above will be described, and the process for implementing the information processing method according to the present embodiment will he described in detail.

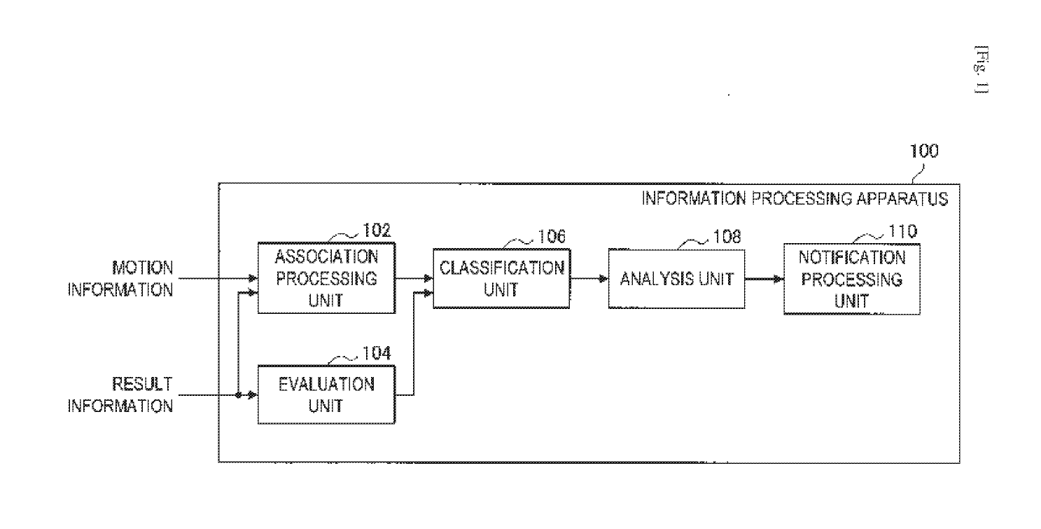

FIG. 1 is a block diagram illustrating an exemplary configuration of an information processing apparatus 100 according to the present embodiment. The information processing apparatus 100 is configured to include an association processing unit 102, an evaluation unit 104, a classification unit 106, an analysis unit 108, and a notification processing unit 110, as an example.

The information processing apparatus 100 may be configured to include a controller (not shown), read-only memory (ROM, not shown), random access memory (RAM, not shown), a storage unit (not shown), a communication unit (not shown), an operation unit (not shown) operable by a user, a display unit (not shown) for displaying various pictures on a display screen, and so on. In the information processing apparatus 100, the components described above are interconnected via a bus that serves as a data transmission channel.

The controller (not shown) is configured to include one or more processors constituted by an arithmetic logic circuit such as micro processing unit (MPU) and various processing circuits, and controls the entire information processing apparatus 100. The controller (not shown) may serve as one or more of the association processing unit 102, the evaluation unit 104, the classification unit 106, the analysis unit 108, and the notification processing unit 110 in the information processing apparatus 100.

One or more of the association processing unit 102, the evaluation unit 104, the classification unit 106, the analysis unit 108, and the notification processing unit 110 may be configured as a dedicated (or general purpose) circuit (e.g., a separate processor from the controller (not shown)) capable of performing the process of each of the association processing unit 102, the evaluation unit 104, the classification unit 106, the analysis unit 108, and the notification processing unit 110.

The ROM (not shown) is used to store data for control such as programs and operation parameters used by the controller (not shown). The RAM (not shown) is used to temporarily store programs and other instructions for execution by the controller (not shown).

The storage unit (not shown) is a storage mechanism provided in the information processing apparatus 100, and stores data, for example, motion information (described later) or result information (described later) used in the information processing method according to the embodiment or stores various data such as a variety of applications.

Examples of the storage unit (not shown) include a magnetic recording medium such as hard disk, and nonvolatile memory such as flash memory. The storage unit (not shown) may be removable from the information processing apparatus 100.

Examples of the communication unit (not shown) include a communication interface described later. Examples of the operation unit (not shown) include an operation input device described later. Examples of the display unit (not shown) include a display device described later.

Exemplary Hardware Configuration of Information Processing Apparatus 100

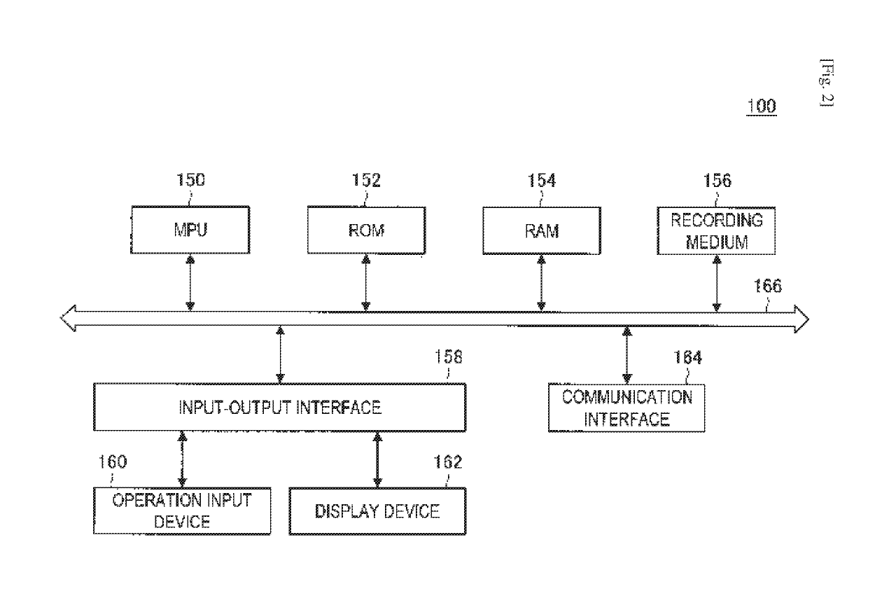

FIG. 2 is a diagram illustrated to describe an exemplary hardware configuration of the information processing apparatus 100 according to the present embodiment. The information processing apparatus 100 may be configured to include an MPU 150, a ROM 152, a RAM 154, a recording medium 156, an input-output interface 158, an operation input device 160, a display device 162, a communication interface 164. In the information processing apparatus 100, the components are interconnected via a bus 166 that serves as a data transmission channel.

The MPU 150 may be configured to include one or more processors constituted by an arithmetic logic circuit such as MPU and various processing circuits, and functions as the controller (not shown) that controls the entire information processing apparatus 100. The MPU 150 serves as the association processing unit 102, the evaluation unit 104, the classification unit 106, the analysis unit 108, or the notification processing unit 110 in the information processing apparatus 100. One or more of the association processing unit 102, the evaluation unit 104, the classification unit 106, the analysis unit 108, and the notification processing unit 110 may be configured as a dedicated (or general purpose) circuit (e.g., a separate processor from the MPU 150) capable of performing the process of each of the association processing unit 102, the evaluation unit 104, the classification unit 106, the analysis unit 108, and the notification processing unit 110.

The ROM 152 stores data for control, such as programs and operation parameters used by the MPU 150. The RAM 154 stores temporarily programs and other data executed by the MPU 150.

The recording medium 156 functions as the storage unit (not shown), and stores data relating to the information processing method according to the embodiment such as motion information (described later) or result information (described later) and a variety of data including various types of applications. Examples of the recording medium 156 include a magnetic recording medium such as hard disk, and nonvolatile memory such as flash memory. The recording medium 156 may be removable from the information processing apparatus 100.

The input-output interface 158 is used for connection of the operation input device 160 and the display device 162. The operation input device 160 functions as the operation unit (not shown). The display device 16:2 functions as the display unit (not shown). Examples of the input-output interface 158 include a universal serial bus (USB) terminal, a digital visual interface (DVI) terminal, a high-definition multimedia interface (HDMI, registered trademark) terminal, and various types of processing circuits.

The operation input device 160 is provided, for example, on the information processing apparatus 100 and is connected to the input-output interface 158 within the information processing apparatus 100. Examples of the operation input device 160 include a button, a direction key, a rotation type selector such as a jog dial, and a combination thereof.

The display device 162 is provided, for example, on the information processing apparatus 100 and is connected to the input-output interface 158 within the information processing apparatus 100. Examples of the display device 162 include a liquid crystal display (LCD) and an organic electro-luminescence (EL) display (or also referred to as an organic light emitting diode (OLED) display).

It will he understood that the input-output interface 158 may be connected to an external device, such as an external operation input device (e.g., keyboard or mouse) or an external display device of the information processing apparatus 100. The display device 162 may be a device such as a touch panel on which a display process and the user's operation can be performed.

The communication interface 164 is a communication mechanism that is provided in the information processing apparatus 100. The communication interface 164 functions as a communication unit (not shown) for communicating with “an external device such as a sensor used to detect a motion of a target user” or “an external apparatus such as one or more servers used to store one or both of motion information (described later) and result information (described later)”, by wire or wireless over a network (or directly).

Examples of the communication interface 164 include a communication antenna and radio frequency (RE) circuit (wireless communication), an IEEE 802.15A port and transmission-reception circuit (wireless communication), an IEEE 802.11 port and transmission-reception circuit (wireless communication), or a local area network (LAN) terminal and transmission-reception circuit (wired communication).

The information processing apparatus 100 having, for example, the configuration shown in FIG. 2 performs the process for implementing the information processing method according to the embodiment. The hardware configuration of the information processing apparatus 100 according to the embodiment is not limited to that shown in FIG. 2.

For example, the information processing apparatus 100,when it communicates with an external apparatus through an external communication device connected thereto or when it performs a process as a stand-alone device, may have a configuration that does not include the communication interface 164. The communication interface 164 may have a configuration capable of communicating with one or more external apparatuses using a plurality of communication schemes.

As one example, the information processing apparatus 100 may be configured to further include one or both of a sensor used to acquire motion information (described later) and a sensor used to acquire result information (described later).

As one example, the information processing apparatus 100 can have a configuration that does not include one or more of the recording medium 156, the operation input device 160, and the display device 162.

As one example, some or all of the components illustrated in FIG. 2 (or components according to a modified example) may be implemented by one or more integrated circuits (ICs).

Referring back to FIG. 1, an exemplary configuration of the information processing apparatus 100 will be described.

### <I> ASSOCIATION PROCESSING UNIT 102

The association processing unit 102 plays a leading role in performing the association process. The association processing unit 102 associates the motion information and the result information with each other.

The motion information according to the present embodiment herein is data indicating a type of a motion of the user.

Examples of the data indicating a type of the user's motion include “data indicating detection results obtained by detecting one or more of the movement of the user's body and the movement of a tool such as a hitting tool used by the user (hereinafter sometimes referred to as “first movement detection data”)” or “data that can be used to estimate one or both of the movement of the user's body and the movement of a tool such as a hitting tool used by the user (hereinafter sometimes referred to as “first movement estimation data”)”. The data indicating a type of the user's motion may contain data indicating a posture (a pose during the exercise or the like) as an example.

Examples of the first movement detection data as an example of the motion information include data indicating a detection result of any movement detection sensor capable of detecting the movement of a detection target, such as optical movement detection sensors (marker-based or markerless-based sensors), magnetic movement detection sensors, and inertial-based movement detection sensors. The user's movement is detected using the movement detection sensors as described above, and thus the motion information can indicate one or more of the three-dimensional movement of the user's joint, the three-dimensional movement of a tool such as hitting tools, and the position where a ball or the like is hit by a tool.

Examples of the first movement estimation data as an example of the motion information include any data that can be used to estimate the movement of a detection target, such as a captured image of a user that is picked up by an imaging device. For example, the process for estimating the user's movement or the like based on the captured image (an example of the first movement estimation data) herein may be performed by the information processing apparatus 100 or may be performed by an external apparatus of the information processing apparatus 100.

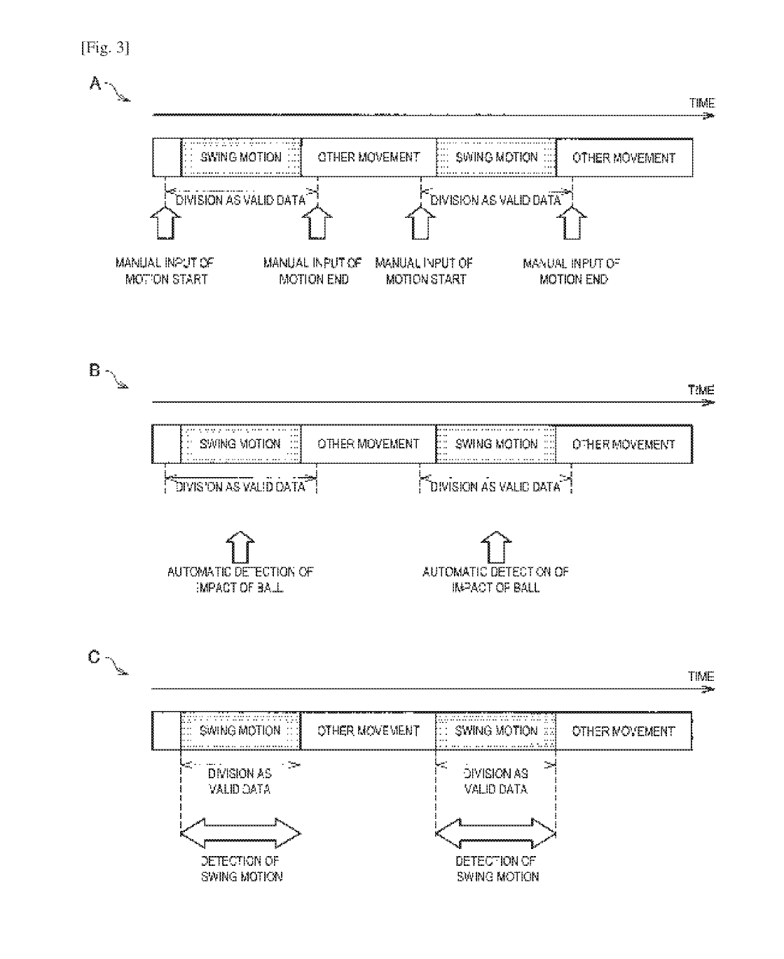

FIG. 3 is a diagram illustrated to describe the information processing method according to the present embodiment, and illustrates an example of the process for generating the motion information. Herein, a process to be described with reference to FIG. 3 is performed, for example, by the movement detection sensors described above or by a device used to generate the motion information such as the imaging device described above.

In the device used to generate the motion information, the motion information corresponding to a motion such as sports is obtained using methods indicated in items (A) to (C) described below. FIG. 3 illustrates an example in which the motion such as sports is a swing motion in golf or tennis. The motion information corresponding to the motion such as sports is sometimes referred to as “valid data” hereinafter.

### (A) FIRST EXAMPLE OF MOTION INFORMATION ACQUISITION (PORTION A OF FIG. 3)

On the basis of a motion start input performed manually before the start of one motion and an a motion end input performed manually after the end of the motion, the device used to generate the motion information regards data (e.g., detection data or captured image data) that is present between the motion start input and the motion end input as valid data corresponding to the motion.

The motion start input and the motion end input herein are performed, for example, by operating an operation device, such as a button, provided in the device used to generate the motion information. The motion start input and the motion end input may be performed, for example, by operating “any wearable device that is used while being worn on the body, such as wristwatch-like or eyewear-like device”, or an external apparatus of the device used to generate the motion information, such as a communication device including smartphones. The external apparatus of the device used to generate the motion information serves as what is called a remote controller.

### (B) SECOND EXAMPLE OF MOTION INFORMATION ACQUISITION (PORTION B OF FIG. 3)

The device used to generate the motion information automatically detects a predetermined timing during a motion such as impact of a ball and regards data that is present for a certain period of time before and after the detected timing (e.g., detection data or captured image data) as valid data. The device used to generate the motion in-formation detects the predetermined timing during a motion, for example, by any process capable of automatically detecting the predetermined timing during the motion, such as a comparison process using the preset data.

### (C) THIRD EXAMPLE OF MOTION INFORMATION ACQUISITION (PORTION C OF FIG. 3)

The device used to generate the motion information automatically detects a predetermined motion such as a swing motion and regards data that is present between the start and end of the detected predetermined motion (e.g., detection data or captured image data) as valid data. The device used to generate the motion information detects the predetermined motion, for example, by any process capable of automatically detecting the motion, such as a comparison process using the preset data.

The result information according to the present embodiment is data indicating a result obtained from the user's motion.

An example of the case of the user's motion in sports that involves a ball such as golf and tennis will be described. Examples of data indicating the result obtained from the user's motion include “data indicating a result obtained by detecting the movement of a ball (sometimes referred to as “second movement detection data” hereinafter)” or “a data that can be used to estimate the trajectory of a ball (sometimes referred to as “second movement estimation data” hereinafter)”.

Examples of the second movement detection data as an example of the result information include data indicating a detection result obtained by a sensor capable of detecting the trajectory of a ball, such as Doppler radar.

Examples of the second movement estimation data as an example of the result information include any data that can be used to estimate the movement of a detection target, such as a captured image of a ball picked up by an imaging device. As one example, the process for estimating the ball's movement or the like based on the captured image (an example of the second movement estimation data) herein may be performed by the information processing apparatus 100 or may he performed by an external apparatus of the information processing apparatus 100.

The association processing unit 102 associates the motion information and the result information with each other in the association process on the basis of first identification information attached to the motion information as described above and second identification information attached to the result information as described above.

The first identification information according to the present embodiment herein is data for identifying the motion information as an example. Examples of the first identification information include items as follows:

Identifier (e.g., ID indicating the motion information)

Time information (e.g., data indicating a time (e.g., date and time) at which the motion information is generated)

The second identification information according to the present embodiment is data that is used to identify the result information as an example. Examples of the second identification information include items as follows:

Identifier (e.g., ID indicating the result information)

Time information (e.g., data indicating a time (e.g., date and time) at e result information is generated)

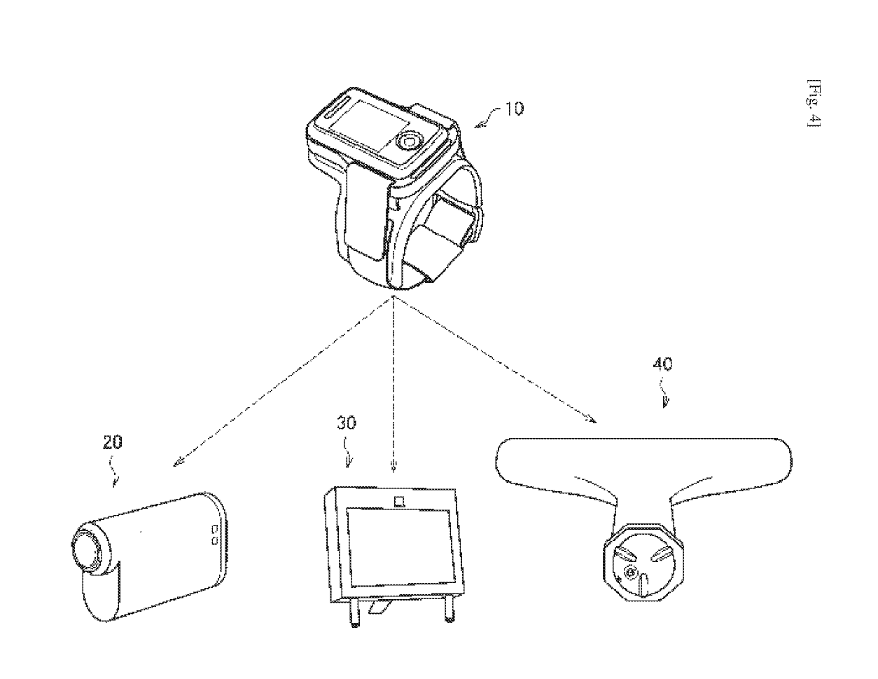

FIG. 4 is a diagram illustrated to describe the information processing method according to the present embodiment, and illustrates an example of the attachment of the first identification information to the motion information and the attachment of the second identification information to the result information. In FIG. 4, an apparatus 10 is an example of the device used to generate the motion information, and apparatuses 20, 30, and 40 are an example of the device used to generate the result information.

In the device used to generate the motion information (apparatus 10 shown in FIG. 4), the first identification information is attached to the motion information using methods indicated in items (a) and (b) described below, as an example. In the device used to generate the result information (apparatuses 20, 30, and 40 shown in FIG. 4), the second result information corresponding to the first identification information is attached to the result information using methods indicated in items (a) and (b) described below, as an example.

### (a) FIRST EXAMPLE OF ATTACHMENT OF FIRST IDENTIFICATION INFORMATION AND SECOND IDENTIFICATION INFORMATION

For example, the device used to generate the motion information (apparatus 10 shown in FIG. 4) generates an identifier when the motion start timing is recognized using any one method of the items (A) to (C) described above. Then, the device used to generate the motion information (apparatus 10 shown in FIG. 4) attaches the generated identifier to the motion information as the first identification information.

The device used to generate the motion information (apparatus 10 shown in FIG. 4) attaches the identifier to the motion information, for example, by embedding the generated identifier in the motion information. The device used to generate the motion information (apparatus 10 shown in FIG. 4) attaches the identifier to the motion information, for example, by attaching the generated identifier to a name (data name or file name) of the motion information. In other words, the identifier of the motion information may be embedded in the motion information or may be embedded in the name of the motion information.

The device used to generate the motion information (apparatus 10 shown in FIG. 4) transmits the generated identifier to each of the devices used to generate the result information (apparatuses 20, 30, and 40 shown in FIG. 4).

Each of the devices used to generate the result information (apparatuses 20, 30, and 40 shown in FIG. 4), when acquiring the identifier transmitted from the device used to generate the motion information (apparatus 10 shown in FIG. 4), attaches the acquired identifier to the result information as the second identification information.

Each of the devices used to generate the result information (apparatuses 20, 30, and 40 shown in FIG. 4) herein attaches the identifier to the result information, for example, by embedding the acquired identifier to the result information. Each of the devices used to generate the result information (apparatuses 20, 30, and 40 shown in FIG. 4) attaches the identifier to the result information, for example, by attaching the acquired identifier to a name (data name or file name) of the result information. In other words, the identifier of the result information may be embedded in the result information or may be embedded in the name of the result information.

The process performed as described above allows the same identifier to be shared between the device used to generate the motion information (apparatus 10 shown in FIG. 4) and the device used to generate the result information (apparatuses 20, 30, and 40 shown in FIG. 4).

### (b) SECOND EXAMPLE OF ATTACHMENT OF FIRST IDENTIFICATION INFORMATION AND SECOND IDENTIFICATION INFORMATION

The time of a timepiece provided in the device used to generate the motion information (apparatus 10 shown in FIG. 4) is synchronized in advance with that of a timepiece provided in the device used to generate the result information (apparatuses 20, 30, and 40 shown in FIG. 4) in a manual or automatic manner.

For example, the device used to generate the motion information (apparatus 10 shown in FIG. 4) generates the motion information using any one method of the above items (A) to (C). Then, the device used to generate the motion information (apparatus 10 shown in FIG. 4) attaches the time information indicating a time at which the motion information is generated to the motion information as the first identification information.

The device used to generate the motion information (apparatus 10 shown in FIG. 4) herein attaches the time information to the motion information, for example, by embedding the time information in the motion information. The device used to generate the motion information (apparatus 10 shown in FIG. 4) attaches the time information to the motion information, for example, by attaching a time indicated by the time information to the name (data name or file name) of the motion information. In other words, for example, the time information of the motion information may be embedded in the motion information, or a time indicated by the time information of the motion information may be contained in the name of the motion information.

The device used to generate the result information (apparatuses 20, 30, and 40 shown in FIG. 4) attaches the time information indicating a time at which the result information is generated to the result information as the second identification information.

The device used to generate the result information (apparatuses 20, 30, and 40 shown in FIG. 4) herein attaches the time information to the result information, for example, by embedding the time information to the result information. The device used to generate the result information (apparatuses 20, 30, and 40 shown in FIG. 4) attaches the time information to the result information, for example, by attaching a time indicated by the time information to the name (data name or file name) of the result information. In other words, for example, the time information of the result information may he embedded in the result information, or a time indicated by the time information of the result information may be contained in the name of the result information.

As described in the above items (a) and (b) for example, the first identification information is attached to the motion information, and the second identification information corresponding to the first identification information is attached to the result information.

Thus, the association processing unit 102 associates the motion information and the result information with each other when the first identification information is consistent with the second identification information.

More specifically, the association processing unit 102 associates the motion information and the result information with each other, for example, by performing any one of a process for a first example described in an item (1) mentioned below or a process for a second example described in an item (2) mentioned below.

### (1) FIRST EXAMPLE OF ASSOCIATION PROCESS

### In Case Where First Identification Information and Second Identification Information are Identifiers

When the first identification information is the identifier of the motion information as described above, the identifier of the motion information is embedded in the motion information or is contained in the name of the motion information, as an example. Furthermore, when the second identification information is the identifier of the result information as described above, the identifier of the result information is embedded in the result information or is contained in the name of the result information, as an example.

The association processing unit 102 compares “the identifier of the motion information that is embedded in the motion information or is contained in the name of the motion information” with the identifier of the result information that is embedded in the result information or is contained in the name of the result information. Then, when the identifier of the motion information is consistent with the identifier of the result information, the motion information and the result information having the same identifier are associated with each other.

The association processing unit 102 herein associates the motion information and the result information with each other, for example, by recording the motion information and the result information having the same identifier in the same record of a table (or a database, and this is similarly applied to the following description). A method of associating the motion information and the result information with each other is not limited to the method of using the table. The motion information and the result information may be associated with each other using any method capable of associating the motion information and the result information with each other.

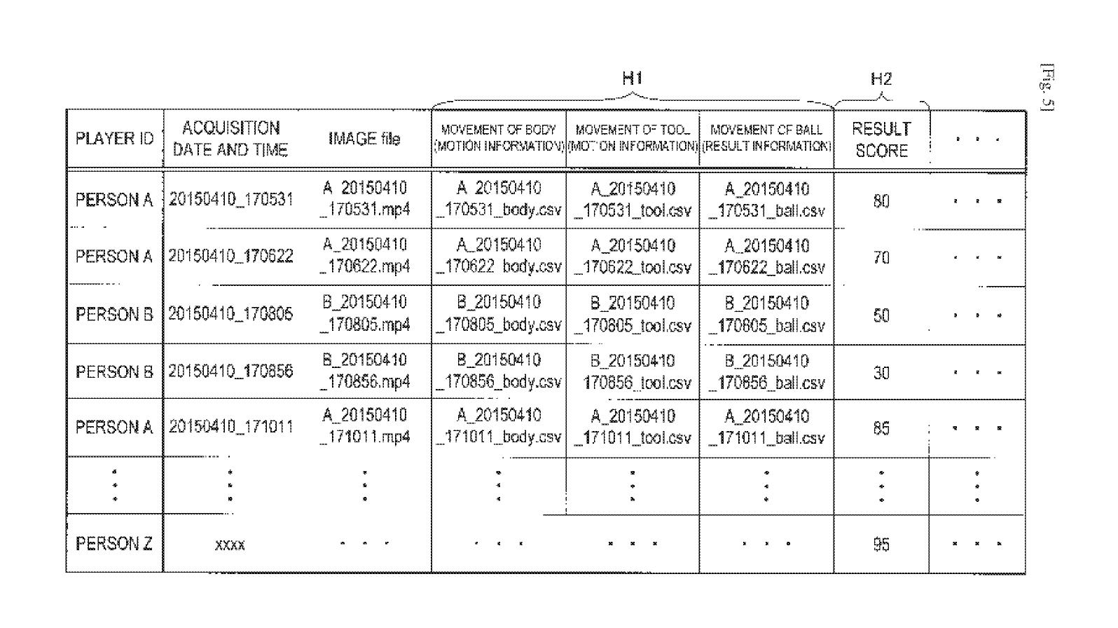

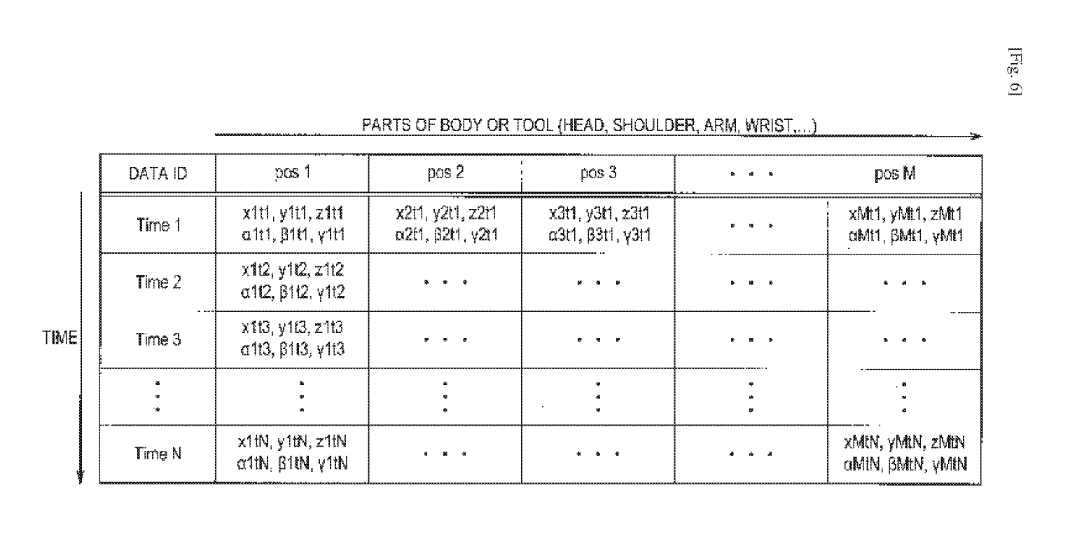

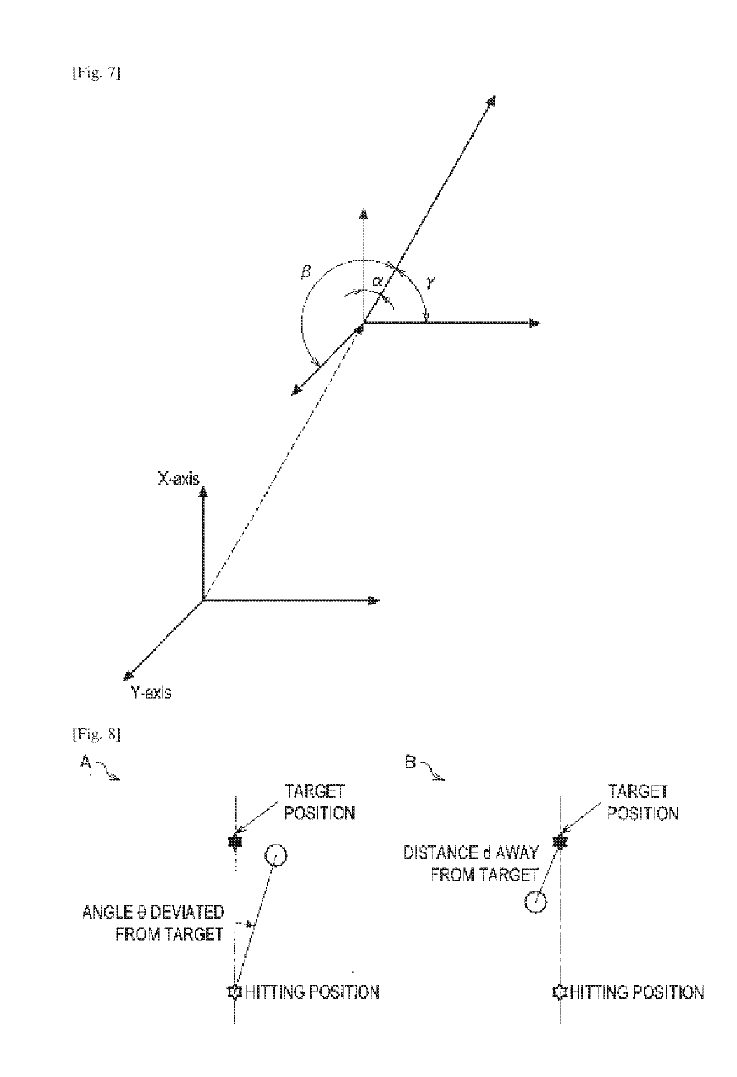

FIGS. 5 to 7 are diagrams illustrated to describe a process for implementing the information processing method according to the present embodiment. FIG. 5 illustrates an example of a table in which the motion information and the result information are associated with each other. FIG. 6 illustrates an example of a data format of each of the motion information and the result information shown in FIG. 5. In FIG. 6, each piece of data is represented, for example, by six degrees of freedom for position and direction as shown in FIG. 7.

In the table shown in FIG. 5, the motion information and the result information are recorded while being associated with each other, for example, as illustrated in the portion H1 of FIG. 5. In the table according to the present embodiment, one or more of information indicating a user (e.g., “player ID” shown in FIG. 5), image data indicating a captured image of a user that is picked up (e.g., “image file” shown in FIG. 5), and a result of an evaluation process described later (e.g., “result score” shown in FIG. 5) may be further associated with the motion information and the result information.

It will be understood that “example of the table according to the present embodiment” is not limited to the example shown in FIG. 5, and “example of a data format and data of each of the motion information and the result information” is not limited to the example shown in FIGS. 6 and 7.

### (2) SECOND EXAMPLE OF ASSOCIATION PROCESS

### In Case Where First Identification Information and Second Identification Information are Time Information

As described above, when the first identification information is the time information, for example, the time information of the motion information is embedded in the motion information or a time indicated by the time information of the motion information is contained in the name of the motion information. As described above, when the second identification information is the time information of the result information, for example, the time information of the result information is embedded in the result information, or a time indicated by the time information of the result information is contained in the name of the result information.

The association processing unit 102 compares “the time information embedded in the motion information or the time indicated by the time information contained in the name of the motion information” with “the time information embedded in the result information or the time indicated by the time information contained in the name of the result information”. Then, when the time indicated by the time information of the motion information is consistent with the time indicated by the time indicated by the time information of the result information, the motion information and the result information having the same time indicated by the time information are associated with each other.

The association processing unit 102 herein associates the motion information and the result information with each other, for example, by recording the motion information and the result information having the same time indicated by the time information in the same record of a table. Note that, as described above, the method of associating the motion information and the result information with each other is not limited to the method of using the table.

### <II> EVALUATION UNIT 104

The evaluation unit 104 plays a leading role in performing the evaluation process. The evaluation unit 104 evaluates the user's motion on the basis of the result information.

More specifically, the evaluation unit 104 evaluates the user's motion by digitizing a result of the user's motion as described in items (i) and (ii) below.

An example described in the item (i) below herein is an example of the evaluation process in the case where the user practices a golf swing, and an example described in the item (ii) below is an example of the evaluation process in the case where the user practices a tennis swing. It will be understood that an example of the process performed by the evaluation unit 104 is not limited to the examples described in the items (i) and (ii) below.

### (i) FIRST EXAMPLE OF EVALUATION PROCESS

FIG. 8 is a diagram illustrated to describe a process for implementing the information processing method according to the present embodiment, and illustrates an overview of the evaluation process based on the result information obtained in the case where the user practices a golf swing.

The evaluation unit 104 calculates an angle θ between the direction of the flight of a ball indicated by the result information and the direction from a position at which the user drives the ball to a target position, for example, as shown in the portion A of FIG. 8. The target position may be automatically set depending on the selected skill level of the user, or may be set to any position by the user.

The evaluation unit 104 digitizes a result of the motion by calculating a score indicating a result obtained from the motion on the basis of the calculated angle θ.

The angle θ herein indicates a gap between the target position and a position where a ball actually reaches, which means that the larger the angle θ, the greater the gap. Thus, the evaluation unit 104 digitizes the result of the motion, for example, by calculating a score using any formula or algorithm defined in such a way that a score indicating a result obtained from the motion decreases as the calculated angle θ increases.

Furthermore, the evaluation unit 104 may change the score to be larger, for example, depending on a position of an area where a ball reaches on a golf course. For example, the evaluation unit 104 sets a score when a ball reaches a “fairway area” on the golf course to be higher than a score when the ball reaches other areas such as “rough area”, “bunker area” and “out-of-bounds area” on the golf course, even on the assumption that the angle θ is the same.

For example, as shown in the portion A of FIG. 8, the digitization of a result of the motion on the basis of the angle θ is considered to be effective, particularly in the case of evaluating a result of the motion of the user having a skill level that is difficult to drive a ball straight into the air. It will be understood that the digitization of a result of the motion based on the angle θ makes it possible to evaluate a result of the motion of a user having a skill level other than the user having a skill level that is difficult to drive a ball straight into the air.

The evaluation unit 104 is also capable of digitizing a result of the motion, for example, by calculating a distance d between the position where a ball reaches indicated by the result information and the target position and by calculating a score indicating a result obtained from the motion based on the distance d as shown in the portion B of FIG. 8.

The distance d herein indicates a gap between the target position and the position where a ball actually reaches, which means that the large the distance d, the greater the gap. Thus, the evaluation unit 104 digitizes the result of the motion, for example, by calculating a score using any formula or algorithm defined in such a way that a score indicating a result obtained from the motion decreases as the calculated distance d increases.

When the score is calculated on the basis of the distance d, the distance d may be normalized by a target distance previously set. The normalization of the distance d by the target distance allows an effect that the calculated score can he set to a value closer to a human sense to be expected. The target distance herein may be automatically set depending on the selected skill level of the user, or may be set by the user.

The evaluation unit 104 may change the score to be larger, for example, depending on a position of an area where a ball reaches on a golf course. For example, the evaluation unit 104 sets the score when a ball reaches a “fairway area” on the golf course to be higher than the score when the ball reaches other areas such as “rough area”, “bunker area” and “out-of-bounds area” on the golf course, even on the assumption that the distance d is the same.

For example, as shown in the portion B of FIG. 8, the digitization of a result of the motion based on the distance d is considered to be effective, particularly in the case of evaluating a result of the motion of the user having a skill level that can drive a ball straight into the air but may cause variation in the distances. It will be understood that the digitization of a result of the motion based on the distance d makes it possible to evaluate a result of the motion of a user having a skill level other than the user having a skill level that can drive a ball straight into the air but may cause variation in the distances.

The evaluation unit 104 digitizes a result of the user's motion on the basis of the result information, for example as shown with reference to FIG. 8. The score as the digitized result of the motion herein indicates a gap between the target position and the position where a ball actually reaches. Thus, the digitization of a result of the user's motion based on the result information as described above allows the user's motion to be evaluated.

The evaluation unit 104 may associate the score as the digitized result of the motion with the result information used in calculating the score, for example as shown in the portion H2 of FIG. 5.

The evaluation process according to the first example is not limited to the process based on the result information shown with reference to FIG. 8.

For example, the evaluation unit 104 is also capable of performing quantitative evaluation using a score and performing qualitative evaluation such as “good”, “moderately satisfied”, and “bad”, on the basis of the input operation by the user. Examples of an input operation by the user herein include various operations such as an operation using a button that constitutes an operation unit (not shown and a voice input operation through a voice input device, for example, a microphone.

### (i) SECOND EXAMPLE OF EVALUATION PROCESS

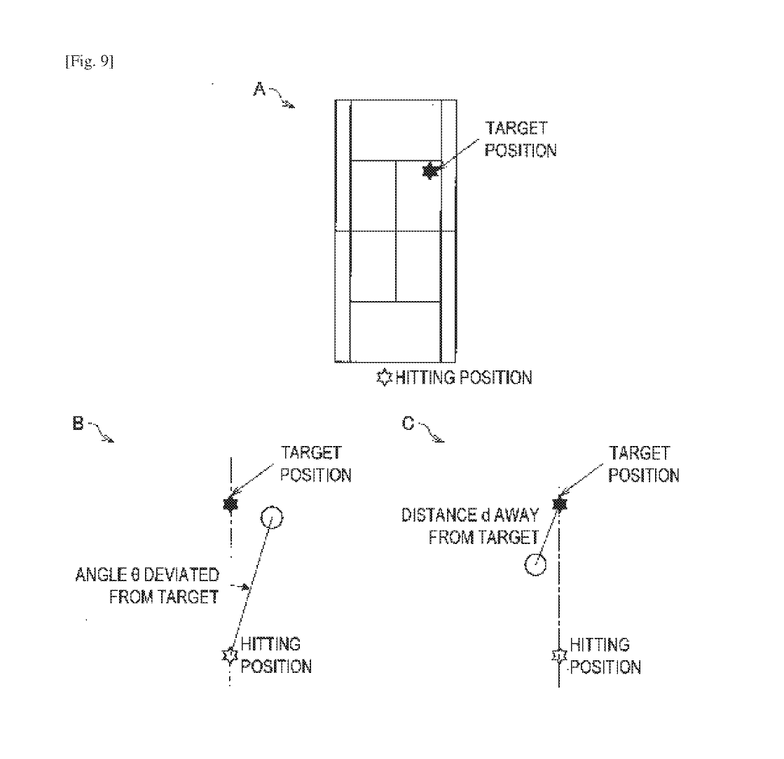

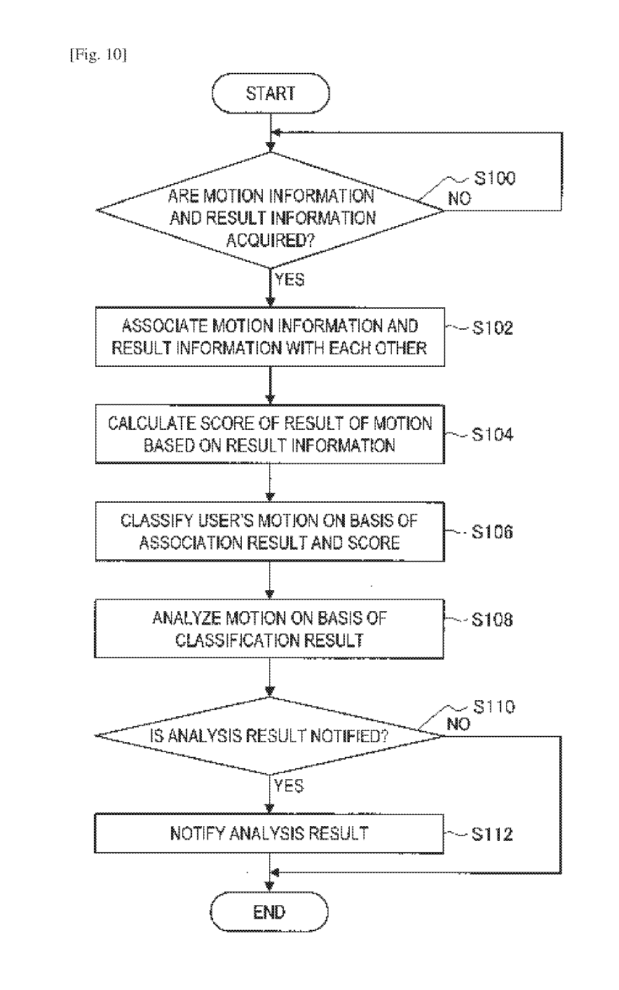

FIG. 9 is a diagram illustrated to describe a process for implementing the information processing method according to the present embodiment, and illustrates an overview of the evaluation process based on the result information obtained when the user practices a tennis swing.

The portion A of FIG. 9 illustrates an example of a position at which the user hits the ball and a target position. The target position may be automatically set depending on the selected skill level of the user, or may be set to any position by the user.

The evaluation unit 104 calculates an angle 0 between the direction of the flight of a ball indicated by the result information and the direction from a position at which the user hits the ball to the target position, for example as shown in the portion B of FIG. 9.

The evaluation unit 104 digitizes a result of the motion by calculating a score indicating a result obtained from the motion on the basis of the calculated angle θ.

The angle θ herein indicates a gap between the target position and a position where a ball is actually landed, which means that the larger the angle θ, the greater the gap. Thus, the evaluation unit 104 digitizes the result of the motion, for example, by calculating a score using any formula or algorithm defined in such a way that a score indicating a result obtained from the motion decreases as the calculated angle θ increases.

Furthermore, the evaluation unit 104 may change the score to be larger, for example, depending on whether a position of an area where a ball is landed is “in area” or “out area” on a tennis court. For example, the evaluation unit 104 sets the score when a ball is landed in the “in area” on the tennis court to be higher than the score when the ball is landed in the “out area” on the tennis court, even on the assumption that the angle θ is the same.

For example, as shown in the portion B of FIG. 9, the digitization of a result of the motion based on the angle θ is considered to be effective, particularly in the case of evaluating a result of the motion of the user having a skill level that is difficult to hit a ball straight into the air. It will be understood that the digitization of a result of the motion based on the angle θ makes it possible to evaluate a result of the motion of a user having a skill level other than the user having a skill level that is difficult to hit a ball straight into the air.

The evaluation unit 104 is capable of digitizing a result of the motion, for example, by calculating a distance d between the landing position of a ball indicated by the result information and the target position and by calculating a score indicating a result obtained from the motion based on the distance d, as shown in the portion C of FIG. 9.

The distance d herein indicates a gap between the target position and the position where a ball is actually landed, which means that the larger the distance d, the greater the gap. Thus, the evaluation unit 104 digitizes the result of the motion, for example, by calculating a score using any formula or algorithm defined in such a way that a score indicating a result obtained from the motion decreases as the calculated distance d increases.

When the score based on the distance d is calculated, the distance d may be normalized by a target distance previously set. The normalization of the distance d by the target distance allows an effect that the calculated score can be set to a value closer to a human sense to be expected. The target distance herein may be automatically set depending on the selected skill level of the user, or may be set by the user.

The evaluation unit 104 may change the score to be larger, for example, depending on whether a position of an area where a ball is landed is “in area” or “out area” on a tennis court. For example, the evaluation unit 104 sets the score when a ball is landed in the “in area” on the tennis court to be higher than the score when the ball is landed in the “out area” on the tennis court, even on the assumption that the distance d is the same.

For example as shown in the portion C of FIG. 9, the digitization of a result of the motion based on the distance d is considered to be effective, particularly in the case of evaluating a result of the motion of the user having a skill level that can hit a ball straight into the air but may cause variation in the distances. It will be understood that the digitization of a result of the motion based on the distance d makes it possible to evaluate a result of the motion of a user having a skill level other than the user having a skill level that can hit a ball straight into the air but may cause variation in the distances.

The evaluation unit 104 digitizes a result of the user's motion on the basis of the result information, for example as shown with reference to FIG. 9. The score as the digitized result of the motion herein indicates a gap between the target position and the position where a ball is actually landed. Thus, the digitization of a result of the user's motion based on the result information as described above allows the user's motion to be evaluated.

The evaluation unit 104 may associate the score as the digitized result of the motion with the result information used in calculating the score, similarly to the evaluation process according to the first example described in the above item (i).

The evaluation process according to the second example is not limited to the process based on the result information shown with reference to FIG. 9.

For example, the evaluation unit 104 is capable of performing the quantitative evaluation using a score or the qualitative evaluation such as “good”, “moderately satisfied”, and “bad”, on the basis of the input operation by the user, similarly to the evaluation process according to the first example described in the above item (i).

### <III> CLASSIFICATION UNIT 106

The classification unit 106 plays a role in performing a first process using the result obtained from the association process and the result obtained from the evaluation process, and it plays a leading role in the classification process as a process using the results obtained from these processes.

The classification unit 106 classifies the motion indicated by the motion information into a plurality of segments on the basis of the result obtained from the association process by the association processing unit 102 (a result obtained by associating the motion information and the result information with each other) and the result obtained from the evaluation process by the evaluation unit 104 (a result obtained by evaluating the user's motion based on the result information).

As one example, the result obtained from the association process indicates the process performed by the classification unit 106 when the result is represented in the table shown in FIG. 5.

The classification unit 106 classifies the motion information associated with a score (an example of the result obtained from the evaluation process by the evaluation unit 104, and this corresponds to the result score shown in the portion H2 of FIG. 5) by a threshold process that uses the score and one or more thresholds for each user (specified by player IDs in FIG. 5). The classification unit 106 classifies the motion information based on the score by segmenting the qualitative evaluation such as “good”, “moderately satisfied”, and “bad”, as an example.

A specific example of the classification of the motion information based on the score by the classification unit 106 includes examples described below. It will be understood that examples of the classification of the motion information based on the score by the classification unit 106 are not limited to the examples described below.

“Good”: Score of 75 or more

“Moderately satisfied”: Score of 50 or more and less than 75

“Bad”: Score of less than 50

The classification unit 106 classifies the motion indicated by the motion information into a plurality of segments on the basis of the result obtained from the association process and the result obtained from the evaluation process by the evaluation unit 104, for example as described above.

The process to be performed by the classification unit 106 is not limited to the above examples. For example, when the evaluation unit 104 performs the qualitative evaluation such as “good”, “moderately satisfied”, and “bad”, the classification unit 106 is capable of classifying the motion indicated by the motion information into a plurality of segments by classifying the motion information by the qualitative evaluation.

### <IV> ANALYSIS UNIT 108

The analysis unit 108 plays a role in performing a second process using the result obtained from the association process and the result obtained from the evaluation process, and it plays a leading role in the analysis process as a process using the results obtained from these processes. The analysis unit 108 analyzes the user's motion on the basis of a result obtained by classification in the classification unit 106 (a result obtained by classifying the motion indicated by the motion information).

The analysis unit 108 analyzes the user's motion by calculating the difference between the user's motions that belong to different segments in the result obtained by classification in the classification unit 106. Examples of the different segments from which the difference is calculated by the analysis unit 108 include examples described below. It will be understood that examples of the different segments from which the difference is calculated by the analysis unit 108 are not limited to the examples described below.

Motion classified as “good” and motion classified as “bad”

Motion classified as “good” and motion classified as “moderately satisfied”

Motion classified as “moderately satisfied” and motion classified as “bad”

The analysis unit 108 calculates the difference between the user's motions that belong to different segments, for example, by statistically analyzing a movement indicated by the motion information.

As one example, the analysis unit 108 calculates the difference between the user's motions that belong to different segments using any technique such as a weighted least square method or random sample consensus (RANS AC). Furthermore, the analysis unit 108 may calculate the difference between the motions for each part of the body.

The analysis unit 108 is capable of calculating the difference between the user's motions that belong to different segments, for example, by analyzing main components of the motion and by calculating the difference between the main components.

### <V> NOTIFICATION PROCESSING UNIT 110

The notification processing unit 110 plays a role in performing a third process using the result obtained from the association process and the result obtained from the evaluation process, and it plays a leading role in the notification process as a process using the results obtained from these processes.

The notification processing unit 110 causes a result obtained by analysis in the analysis unit 108 (a result obtained by analyzing the user's motion) to be notified as the notification process.

For example, the notification processing unit 110 reads out image data corresponding to the user's motion having the largest difference in the result obtained by analysis in the analysis unit 108 from a recording medium such as a storage unit (not shown). Furthermore, the notification processing unit 110 is also capable of reading out image data corresponding to the closest motion to the average movement in each segment in which the difference is calculated.

Examples of the image data that is read out from the recording medium herein include image data (the image file shown in FIG. 5) associated with the motion information in the table shown in FIG. 5. Examples of the image data corresponding to the user's motion include data indicating a captured image of the user's motion that is picked up. Furthermore, the image data corresponding to the user's motion may be any representation data capable of represent the motion such as a stick picture.

The notification processing unit 110 causes the result obtained by analysis in the analysis unit 108 to be notified as a visual representation by displaying an image indicating the read image data on a display screen of a display unit (not shown) or a display screen of an external display device.

As one example, the notification processing unit 110 causes an image indicated by the image data corresponding to the motion classified as “good” and an image indicated by the image data corresponding to the motion classified as “bad” to be displayed together on a display screen.

The notification processing unit 110 may highlight the difference between the motions. Examples of a method of highlighting the difference between the movements herein include any method capable of highlighting it as a visual representation such as “a method of changing the color of a part having large difference between motions in a captured image, stick picture, or the like” or “a method of blinking a part having large difference between motions in a captured image, stick picture, or the like”, as an example.

The information processing apparatus 100 having the configuration shown in FIG. 1 as an example, performs the processes for implementing the information processing method according to the present embodiment (e.g., the association process, the evaluation process, the classification process, the analysis process, and the notification process).

The configuration of the information processing apparatus according to the present embodiment is not limited to that shown in FIG. 1.

As one example, the information processing apparatus according to the present embodiment may have a configuration that does not include “the notification processing unit 110”, “the analysis unit 108 and the notification processing unit 110”, “the classification unit 106, the analysis unit 108, and the notification processing unit 110” or “the evaluation unit 104, the classification unit 106, the analysis unit 108, and the notification processing unit 110” shown in FIG. 1.

Even when the information processing apparatus according to the, present embodiment has a configuration that does not include “the notification processing unit 110”, “the analysis unit 108 and the notification processing unit 110”, “the classification unit 106, the analysis unit 108, and the notification processing unit 110” or “the evaluation unit 104, the classification unit 106, the analysis unit 108, and the notification processing unit 110”, the information processing apparatus is capable of performing the association process.

Thus, even when the information processing apparatus according to the present embodiment has a configuration that does not include “the notification processing unit 110”, “the analysis unit 108 and the notification processing unit 110”, “the classification unit 106, the analysis unit 108, and the notification processing unit 110” or “the evaluation unit 104, the classification unit 106, the analysis unit 108, and the notification processing unit 110”, it is possible for the information processing apparatus according to the present embodiment to achieve the skill improvement in the user's motion. In addition, even when the information processing apparatus according to the present embodiment has a configuration that does not include “notification processing unit 110”, “the analysis unit 108 and the notification processing unit 110”, “the classification unit 106, the analysis unit 108, and the notification processing unit 110” or “the evaluation unit 104, the classification unit 106, the analysis unit 108, and the notification processing unit 110”, it is possible for the information processing apparatus according to the present embodiment to achieve the effects achieved from the association process described above.

As described above, “the association process”, “the association process and the evaluation process”, and “the association process, the evaluation process, and the process using a result of the association process and a result of the evaluation process (e.g., one or more of the classification process, the analysis process, and the notification process)” are those obtained by dividing the process for implementing the information processing method according to the present embodiment for convenience sake. Thus, the type of the components to perform the process for implementing the information processing method according to the present embodiment are not limited to the association processing unit 102, the evaluation unit 104, the classification unit 106, the analysis unit 108, and the notification processing unit 110 shown in FIG. 1. The type of the components to perform the process for implementing the information processing method according to the present embodiment can depend on a way of dividing the process for implementing the information processing method according to the present embodiment.

### <VI> EXAMPLE OF PROCESS FOR IMPLEMENTING INFORMATION PROCESSING METHOD ACCORDING TO PRESENT EMBODIMENT

An example of the process for implanting the information processing method according to the present embodiment in the information processing apparatus 100 shown in FIG. 1 will be described.

FIG. 10 is a flowchart illustrating an example of the process for implementing the information processing method according to the present embodiment, and illustrates an example of the process in the information processing apparatus 100 shown in FIG. 1. Steps S100 and S102 shown in FIG. 10 correspond to the association process. Step S104 shown in FIG. 10 corresponds to the evaluation process, and step S106 shown in FIG. 10 corresponds to the classification process. Step S108 shown in FIG. 10 corresponds to the analysis process, and steps S110 and S112 shown in FIG. 10 correspond to the notification process.

The process in steps S100 and S102 are performed, for example, by the association processing unit 102 in the information processing apparatus 100 shown in FIG. 1. In the information processing apparatus 100 shown in FIG. 1, the process in step S104 is performed by the evaluation unit 104 and the process in step S106 is performed by the classification unit 106. In the information processing apparatus 100 shown in FIG. 1, the process in step S108 is performed by the analysis unit 108 and the process in steps S110 and S112 are performed by the notification processing unit 110.

The information processing apparatus 100 determines whether the motion information and the result information are acquired (S100). The motion information and the result information are acquired by the information processing apparatus 100 reading out them from a recording medium or the like, or by the information processing apparatus 100 acquiring the motion information and the result information transmitted from an external apparatus.

If it is not determined that the motion information and the result information are acquired in step S100, the information processing apparatus 100 does not proceed to the next step until it is determined that the motion information and the result information are acquired in step S100.

On the other hand, if it is determined that the motion information and the result information are acquired in step S100, the information processing apparatus 100 associates the motion information and the result information with each other (S102). For example, the information processing apparatus 100 associates the motion information and the result information with each other, for example, by performing any one of the process according to the first example described in the above item (1) or the process according to the second example described in the above item (2).

The information processing apparatus 100 calculates a score for a result of the user's motion on the basis of the result information (S104). The information processing apparatus 100 calculates a score for a result of the user's motion, for example, by performing the process according to the first example described in the above item (i) or the process according to the second example described in the above item (ii).

When the process in steps S102 and S104 is performed, the information processing apparatus 100 classifies the uses motion on the basis of a result obtained from the association by the process in step S102 and a score obtained by the process in step S104 (S106). The information processing apparatus 100 performs the threshold process using the score obtained from the process in step S104 and one or more thresholds to classify the motion information associated with the score. In other words, the information processing apparatus 100 classifies the motion information associated with the result information used to acquire the score.

The information processing apparatus 100 analyzes the user's motion on the basis of the result obtained from the classification by the process in step S106 (S108). The information processing apparatus 100 analyzes the user's motion, for example, by calculating the difference between the user's motions that belong to different segments in the result obtained from the classification by the process in step S106.

The information processing apparatus 100 determines whether a result obtained from the analysis by the process in step S108 is notified (S110). The information processing apparatus 100 determines that the result obtained from the analysis is notified when the signal in response to the user operation to start the notification is detected or when the notification is set to be automatically performed (S110). The user operation to start the notification herein is performed, for example, by one or both of an operation device that constitutes an operation unit (not shown) and an external apparatus of the information processing apparatus 100.

If it is not determined that the result obtained from the analysis is notified in step S110, the information processing apparatus 100 terminates the process shown in FIG. 10, as an example.

On the other hand, if it is determined that the result obtained from the analysis is notified in step S110, the information processing apparatus 100 notifies the result obtained from the analysis by the process in step 5108 (S112). For example, the information processing apparatus 100 notifies the result obtained from the analysis by causing a picture of the image data corresponding to the user's motion having the largest difference to be displayed on a display screen in such a way that the difference between the motions to be highlighted.

The information processing apparatus 100 performs, for example, the process shown in FIG. 10 as the process for implementing the information processing method according to the present embodiment.

The process for implementing the information processing method according to the present embodiment is not limited to the process shown in FIG. 10.

For example, it is possible for the information processing apparatus 100 not to perform “process in steps S110 and S112”, “process in steps S108 to S112”, “process in steps S106 to S112”, or “process in steps S104 to S112”.

Even when “process in steps 5110 and S112”, “process in steps S108 to S112”, “process in steps S106 to S112” or “process in steps S104 to S112” is not performed, the information processing apparatus 100 can perform the association process.

Thus, even when “process in steps S110 and S112”, “process in steps S108 to S112”, “process in steps S106 to S112”, or “process in steps S104 to S112” is not performed, it is possible for the information processing apparatus according to the present embodiment to facilitate the skill improvement in the user's motion. Furthermore, even when “process in steps S110 and S112”, “process in steps S108 to S112”, “process in steps S106 to S112”, or “process in steps S104 to S112” is not performed, it is possible for the information processing apparatus according to the present embodiment to achieve the effects achieved from the association process described above.

### <VII> EXAMPLE OF EFFECTS ACHIEVED BY USING INFORMATION PROCESSING METHOD ACCORDING TO PRESENT EMBODIMENT

The information processing apparatus 100 can achieve the effects described below as an example. It will be understood that the effects achieved by using the information processing method according to the present embodiment are not limited to those described below.

Extraction of whether a result of motion is good or bad and of difference between movements and presentation of them to the user are possible.

Such presentation allows skill improvement in sports or the like to be achieved efficiently.

### <VII> APPLICATION EXAMPLE OF INFORMATION PROCESSING APPARATUS ACCORDING TO PRESENT EMBODIMENT

In the above, the information processing apparatus has been described as one example, but embodiments of the present disclosure are not limited thereto. The present embodiment is applicable to various types of devices capable of performing the process for implementing the information processing method according to the present embodiment. Examples of such devices include a computer such as personal computers (PCs) and servers, tablet type apparatus, communication apparatus such as mobile phones and smartphones, wearable device used by the user while being worn. The present embodiment is applicable to a processing IC that can be incorporated into such devices.

The information processing apparatus according to the present embodiment may be applied to a system including a plurality of devices under the condition that the devices are connected to a network (or communication between apparatuses), such as cloud computing. In other words, the information processing apparatus according to the present embodiment described above is also capable of being implemented as an information processing system having a plurality of devices that perform the process for implementing the information processing method according to the present embodiment. An example of the information processing system performing the process for implementing the information processing method according to the present embodiment using the plurality of devices includes a system in which “the association process”, “the association process and the evaluation process”, and “the association process, the evaluation process, and the process using a result of the association process and a result of the evaluation process (e.g., one or more of the classification process, the analysis process, and the notification process)” are performed in conjunction with a plurality of devices that constitute the information processing system.

### Program According to Present Embodiment

A program for causing a computer to function as the information processing apparatus according to the present embodiment may be executed by a processor or like device in the computer (e.g., program capable of executing the process for implementing the information processing method according to the present embodiment, such as which “the association process”, “the association process and the evaluation process”, and “the association process, the evaluation process, and the process using a result of the association process and a result of the evaluation process (e.g., one or more of the classification process, the analysis process, and the notification process)”). Thus, it is possible to facilitate the skill improvement in the user's motion.

Moreover, when a program that causes a computer to function as the information processing apparatus according to the present embodiment is executed by a processor or the like in the computer, it is possible to provide an effect provided by the processing related to the information processing method according to the present embodiment described above.

It should be understood by those skilled in the art that various modifications, combinations, sub-combinations and alterations may occur depending on design requirements and other factors insofar as they are within the scope of the appended claims or the equivalents thereof.

For example, it has been illustrated above that a program (computer program) that causes a computer to function as the information processing apparatus according to the present embodiment is provided, but the present embodiment can further provide a recording medium in which the above-described program is stored together.

The above-described configurations express examples of the embodiment and, of course, pertain to the technical scope of the present disclosure.

In addition, the effects described in the present specification are merely illustrative and demonstrative, and not limitative. In other words, the technology according to the present disclosure can exhibit other effects that are evident to those skilled in the art along with or instead of the effects based on the present specification.

Additionally, the present technology may also be configured as below.

(1)

An information processing method, the method comprising: receiving motion information indicative of a motion of a user and result information indicative of a result obtained from the motion of the user; associating the motion information and the result information with each other; and classifying the motion information based at least in part on the association of the motion information and the result information with each other.

(2)

The information processing method according to (1), further comprising: generating, with a first external observer device, the motion information based on the motion of the user;

outputting, with the first external observer device, the motion information to a control unit;

generating, with a second external observer device, the result information based on the result obtained from the motion of the user; and

outputting, with the second external observer device, the result information to the control unit.

(3)

The information processing method according to (2),

wherein generating the motion information based on the motion of the user further includes

determining whether the motion of the user is relevant information, wherein the relevant information is an interaction between the user and an object; and responsive to determining that the motion of the user is the relevant information, generating the motion information based on the relevant information.

(4)

The information processing method according to (2) or (3),

wherein the first external observer device is one of a first imaging apparatus or a first Doppler radar device, and wherein the second external observer device is one of a second imaging apparatus or a second Doppler radar device.

(5)

The information processing method according to (2) or (3),

wherein the first external observer device and the second external observer device are the same external observer device.

(6)

The information processing method according to any of (1) through (5),

wherein associating the motion information and the result information with each other is based on a first identification information of the motion information and a second identification information of the result information.

(7)

The information processing method according to (6),

wherein the associating the motion information and the result information with each other further includes

determining whether the first identification information is consistent with the second identification information; and

responsive to determining that the first identification information is consistent with the second identification information, associating the motion information and the result information with each other.

(8)

The information processing method according to (6) or (7),

wherein the first identification information is an identifier of the motion information, and

wherein the second identification information is an identifier of the result information.

(9)

The information processing method according to (8),

wherein the identifier of the motion information is embedded in the motion information, and

wherein the identifier of the result information is embedded in the result information.

(10)

The information processing method according to (8),

wherein the identifier of the motion information is contained in a name of the motion information, and

wherein the identifier of the result information is contained in a name of the result information.

(11)

The information processing method according to any of (6) through (10),

wherein the first identification information has a first time information that is indicative of a time that the motion information was generated by a first external apparatus, and

wherein the second identification information has a second time information that is indicative of a time that the result information was generated by a second external apparatus.

(12)

The information processing method according to (11),

wherein the first time information is embedded in the motion information, and

wherein the second time information is embedded in the result information.

(13)

The information processing method according to (11),

wherein the time indicated by the first time information is contained in a name of the motion information, and

wherein the time indicated by the second time information of the result information is contained in a name of the result information.

(14)

The information processing method according to any of (1) through (13), further comprising evaluating the result information based on a target of the user.

(15)

The information processing method according to (14),

wherein evaluating the result information includes digitizing the result information; and

scoring the result information based on the target of the user.

(16)

The information processing method according to (14) or (15),

wherein classifying the motion information based at least in part on the association of the motion information and the result information with each other further includes classifying the motion information into a plurality of segments based on the association of the motion information and the result information with each other and the evaluation of the result information.

(17)

The information processing method according to (16), further comprising: analyzing the motion of the user on based on the classification of the motion information.

(18)

The information processing method according to (17),

wherein analyzing the motion of the user further includes calculating a difference between the plurality of segments.

(19)

The information processing method according to (17) or (18), further comprising notifying the classification of the motion information.

(20)

The information processing method according to any of (1) through (19),

wherein the motion information includes information indicative of a swing motion of the user.

(21)

The information processing method according to any of (1) through (20),

wherein the result information includes information indicative of a motion or a trajectory of a ball.

(22)

An information processing system, the information processing system comprising:

one or more external observers configured to

generate motion information indicative of a motion of a user and result information indicative of a result obtained from the motion of the user, and

output the motion information and the result information; and

a control unit having an association processing unit and a classification unit, wherein the association processing unit is configured to

receive the motion information and the result information, and

associate the motion information and the result information with each other, and

wherein the classification unit is configured to classify the motion information based at least in part on the association of the motion information and the result information with each other.

(23)

A non-transitory computer-readable medium comprising instructions, that when executed by an electronic processor, cause the electronic processor to perform a set of functions comprising:

receiving motion information indicative of a motion of a user and result information indicative of a result obtained from the motion of the user;

associating the motion information and the result information with each other; and classifying the motion information based at least in part on the association of the motion information and the result information with each other.

### REFERENCE SIGNS LIST

10, 20, 30, 40 apparatus

100 information processing apparatus

102 association processing unit

104 evaluation unit

106 classification unit

108 analysis unit

110 notification processing unit

1. An information processing method, the method comprising:
receiving motion information indicative of a motion of a user and result information indicative of a result obtained from the motion of the user;
associating the motion information and the result information with each other; and
classifying the motion information based at least in part on the association of the motion information and the result information with each other.

2. The information processing method according to claim 1, further comprising:
generating, with a first external observer device, motion information based on the motion of the user;
outputting, with the first external observer device, the motion information to a control unit;
generating, with a second external observer device, the result information based on the result obtained from the motion of the user; and
outputting, with the second external observer device, the result information to the control unit.

3. The information processing method according to claim 2,
wherein generating the motion information based on the motion of the user further includes
determining whether the motion of the user is relevant information,
wherein the relevant information is an interaction between the user and an object; and
responsive to determining that the motion of the user is the relevant information, generating the motion information based on the relevant information.

4. The information processing method according to claim 2,
wherein the first external observer device is one of a first imaging apparatus or a first Doppler radar device, and
wherein the second external observer device is one of a second imaging apparatus or a second Doppler radar device.

5. The information processing method according to claim 2,
wherein the first external observer device and the second external observer device are the same external observer device.

6. The information processing method according to claim 1,
wherein associating the motion information and the result information with each other is based on a first identification information of the motion information and a second identification information of the result information.

7. The information processing method according to claim 6,
wherein the associating the motion information and the result in formation with each other further includes
determining whether the first identification information is consistent with the second identification information; and
responsive to determining that the first identification information is consistent with the second identification information, associating the motion information and the result information with each other.

8. The information processing method according to claim 6,
wherein the first identification information is an identifier of the motion information, and
wherein the second identification information is an identifier of the result information.

9. The information processing method according to claim 8,
wherein the identifier of the motion information is embedded in the motion information, and
wherein the identifier of the result information is embedded in the result information.

10. The information processing method according to claim 8,
wherein the identifier of the motion information is contained in a name of the motion information, and
wherein the identifier of the result information is contained in a name of the result information.

11. The information processing method according to claim 6,
wherein the first identification information has a first time information that is indicative of a time that the motion information was generated by a first external apparatus, and
wherein the second identification information has a second time information that is indicative of a time that the result information was generated by a second external apparatus.

12. The information processing method according to claim 11,
wherein the first time information is embedded in the motion information, and wherein the second time information is embedded in the result information.

13. The information processing method according to claim 11,
wherein the time indicated by the first time information is contained in a name of the motion information, and
wherein the time indicated by the second time information of the result information is contained in a name of the result information.

14. The information processing method according to claim 1, further comprising evaluating the result information based on a target of the user.

15. The information processing method according to claim 14,
wherein evaluating the result information includes digitizing the result information; and
scoring the result information based on the target of the user.

16. The information processing method according to claim 14,
wherein classifying the motion information based at least in part on the association of the motion information and the result information with each other further includes classifying the motion information into a plurality of segments based on the association of the motion information and the result information with each other and the evaluation of the result information.

17. The information processing method according to claim 16, further comprising;
analyzing the motion of the user on based on the classification of the motion information.

18. The information processing method according to claim 17,
wherein analyzing the motion of the user further includes calculating a difference between the plurality of segments.

19. The information processing method according to claim 17, further comprising notifying the classification of the motion information.

20. The information processing method according to claim 1,
wherein the motion information includes information indicative of a swing motion of the user.

21. The information processing method according to claim 1, wherein the result information includes information indicative of a motion or a trajectory of a ball.

22. An information processing system, the information processing system comprising:
one or more external observers configured to
generate motion information indicative of a motion of a user and result information indicative of a result obtained from the motion of the user, and
output the motion information and the result information; and
a control unit having an association processing unit and a classification unit, wherein the association processing unit is configured to receive the motion information and the result information, and associate the motion information and the result information with each other, and
wherein the classification unit is configured to classify the motion information based at least in part on the association of the motion information and the result information with each other.

23. A non-transitory computer-readable medium comprising instructions, that when executed by an electronic processor, cause the electronic processor to perform a set of functions comprising:
receiving motion information indicative of a motion of a user and result information indicative of a result obtained from the motion of the user;
associating the motion information and the result information with each other; and
classifying the motion information based at least in part on the association of the motion information and the result information with each other.
